(19) United States
(12) Patent Application Publication
(10) Pub. No.: US 2012/0144208 A1
(43) Pub. Date: Jun. 7, 2012

(54) INDEXED TABLE BASED CODE ENCRYPTING/DECRYPTING DEVICE AND METHOD THEREOF

(75) Inventors: Seungjoo KIM, Suwon-Si (KR); Dongho WON, Suwon-Si (KR); Sungkyu CHO, Suwon-Si (KR); Donghwi SHIN, Seoul (KR); Hyesuk JO, Suwon-Si (KR); Donghyun CHOI, Suwon-Si (KR); Jae-Cheol RYOU, Daejeon (KR)

(73) Assignee: The Industry & Academic Cooperation in Chungnam National University, DAEJEON (KR)

(21) Appl. No.: 13/018,244

(22) Filed: Jan. 31, 2011

(30) Foreign Application Priority Data
Dec. 3, 2010 (KR) 10-2010-0122719

(51) Int. Cl. G06F 21/22

(52) U.S. Cl. 713/190

(57) ABSTRACT

An indexed table based code encrypting device adapted to encrypt an executable file of a computer program includes: an index creator configured to classify codes of the executable file into code blocks using a call code and store the number of calls and start addresses of the code blocks; and a block encrypter configured to encrypt the code blocks with encryption keys. An encryption key of a code block (hereinafter, first type code block) called once is created by using a code block calling the first type code block and an encryption key of a code block (hereinafter, second type code block) called twice or more is created by using a random number. The encryption keys of the first and second type code blocks are stored in the executable file.

### BACKGROUND OF THE INVENTION

1. Field of the Invention

The present invention relates to an indexed table based encrypting/decrypting device that encrypts an executable file of a computer program and decrypts an encrypted executable file and a method thereof.

More particularly, the present invention relates to an indexed table based encrypting/decrypting device that uses a code block calling itself to encrypt/decrypt it when it is called once and uses an encryption key created by a random number to encrypt/decrypt a code block called twice or more, and a method thereof.

Also, the present invention relates to an indexed table based encrypting/decrypting device that classifies an executable code into blocks or calculates the number of calls using an indexed table adapted to store a start address, and the number of calls of a code block and the size of a block, and a method thereof.

2. Description of the Related Art

In general, damage to software due to copyright infringement is estimated to be considerable. In particular, copyright infringement has become severe after reverse engineering was widely known. This is because software is completely exposed to attackers due to its characteristics once it is distributed.

Thus, to protect software, techniques against reverse engineering are necessary. A code encryption scheme is a technique for encrypting a binary executable file and is accomplished by encrypting a program at some point after it is compiled. However, a skillful reverse engineer can easily find secret keys of such a scheme. To solve this problem, the code encryption scheme needs a secure key management.

To achieve this, Cappaert and Jung have proposed code encryption schemes that generate a secret key related to a binary code at runtime. However, first, Cappaert cannot generate a correct secret key. If a secret key is not generated properly in a code encryption scheme, it may lead to program crashes or other unintended behaviors. Second, the Jung's scheme makes the length of a code excessively long, and it may lead to an efficiency problem.

### SUMMARY OF THE INVENTION

Accordingly, the present invention has been made to solve the above-mentioned problems occurring in the prior art, and the present invention provides an indexed table based encrypting/decrypting device that uses a code block calling itself to encrypt/decrypt it when it is called once and uses an encryption key created by a random number to encrypt/decrypt a code block called twice or more, and a method thereof.

The present invention also provides an indexed table based encrypting/decrypting device that classifies an executable code into blocks or calculates the number of calls using an indexed table adapted to store a start address, and the number of calls of a code block and the size of a block, and a method thereof.

In accordance with an aspect of the present invention, there is provided an indexed table based code encrypting device adapted to encrypt an executable file of a computer program comprising: an index creator configured to classify codes of the executable file into code blocks using a call code and store the number of calls and start addresses of the code blocks; and a block encrypter configured to the code blocks with encryption keys, wherein an encryption key of a code block (hereinafter, first type code block) called once is created by using a code block calling the first type code block and an encryption key of a code block (hereinafter, second type code block) called twice or more is created by using a random number, and wherein the encryption keys of the first and second type code blocks are stored in the executable file.

Preferably, the execution code is a binary code or an assembly code and the call code is a branch code or a jump code of a binary code or an assembly code.

Preferably, the index creator classifies a series of execution codes including a final execution code as a call code into one code block, and the call code calls another code block other than the code blocks containing the call code.

Preferably, the index creator stores the number of calls of the code block in the indexed table and the number of calls of the code block called by the call code is increased one by one for the call codes of the code blocks to be stored.

Preferably, the block encrypter hashes the call block of the first type code block and creates an encryption key of the first type code block.

Preferably, the block encrypter determines an encryption key of an initial code block as an initial key.

Preferably, the block encrypter encrypts an encryption key of the second type code block as an initial key and stores the encrypted encryption key in a data section of the executable file.

Preferably, the block encrypter stores the indexed table in a data section of the executable file.

Preferably, the index creator stores the size of the code block in the indexed table.

According to another aspect of the present invention, there is provided an indexed table based code decrypting device adapted to decrypt an executable file encrypted by a device according to the present invention, comprising: a block decrypter configured to decrypt an encrypted execution code of the execution file in units of code blocks using an encryption key of the code block, and referring to the indexed table, to create and use an encryption key with a call block of the code block if the code block is a first type code block and to use a stored encryption key of the code block if the code block is a second type code block; and a block re-encrypter configured to re-encrypt the code block if a final call code of the decrypted code block is executed.

Preferably, when the code block is iterated, the block re-encrypter stores the number of iterations in the indexed table and decreases the number of iterations whenever the code block is called and re-encrypts the code block if the number of iterations is zero.

According to still another aspect of the present invention, there is provided an indexed table based code encrypting method for encrypting an executable file of a computer program, comprising the steps of: (b) classifying execution codes of the executable file into code blocks by a call code, storing the number of calls and start addresses of the code blocks in an indexed table, and creating an encryption key for a code block (hereinafter, second type code block) called twice or more with a random number to store the encryption key; and (c) encrypting the code block with an encryption key of the code block and creating an encryption key of a code block (hereinafter, first type code block) called once using a code block (hereinafter, call block) calling the first type code block.

Preferably, the execution code is an assembly code and the call code is a branch code or a jump code of the assembly code.

Preferably, the step (b) comprises the steps of: (b1) inspecting the execution codes sequentially; (b2) extracting, if the inspected execution code is a call code, an address from an operand of the call code; (b3) inserting, if the address is not present in the indexed table, the address into the indexed table as a start address of the code block; (b4) increasing, if the address is present in the indexed table, the number of calls of the code block corresponding to the address; and (b5) generating, if the number of calls of the code block is once or more, an encryption key of the code block with a random key.

Preferably, the step (b) further comprises the step of (b6) calculating, if a final execution code of the executable file is inspected, the sizes of the code blocks and storing the sizes of the code blocks in the indexed table.

According to yet another aspect of the present invention, there is provided an indexed table based code decrypting method for decrypting an encrypted executable file according to the present invention, comprising the steps of: (d) decrypting an encrypted execution code of the executable file in units of code blocks using an encryption key of the code block, and referring to the indexed table, if the code block is a first type code block, creating an encryption key with the call block of the code block to use the encryption key and if the code block is a second type code block, using a stored encryption key of the code block; and (f) re-encrypting, if a final execution code of the decrypted code block is executed, the code block.

According to the present invention, safe code encryption can be secured by differently creating encryption keys according to the number of calls of the code block using an indexed table, making it possible to shorten an encryption/decryption performing time period and reduce the amount of data.

### BRIEF DESCRIPTION OF THE DRAWINGS

The above and other aspects, features and advantages of the present invention will be more apparent from the following detailed description taken in conjunction with the accompanying drawings, in which:

FIG. 1 is a systematic diagram illustrating an example of a system for carrying out the present invention;

FIG. 2A is an example of an executable file according to an embodiment of the present invention;

FIG. 2B illustrates a state in which an executable file resides in a memory according to an example of the present invention;

FIG. 3 is a table of abbreviations for the terms used in the present invention;

FIGS. 4A and 4C are flowcharts for explaining an indexed table based code encrypting method according to an embodiment of the present invention;

FIGS. 5A and 5B are pseudo-codes for the indexed table based code encrypting method according to the embodiment of the present invention;

FIG. 6 illustrates an example of a keychain according to the embodiment of the present invention;

FIG. 7 illustrates a programming language and an assembly code according to the embodiment of the present invention;

FIGS. 8 and 9 illustrate an executable code according to the embodiment of the present invention and an example of creating an indexed table;

FIG. 10 is a flowchart for explaining an indexed table based code decrypting method according to an embodiment of the present invention;

FIG. 11 is a pseudo-code of the indexed table based code decrypting method according to the embodiment of the present invention;

FIG. 12 is a block diagram of an indexed table based code encrypting device according to an embodiment of the present invention; and

FIG. 13 is a block diagram of an indexed table based code decrypting device according to an embodiment of the present invention.

### DETAILED DESCRIPTION OF THE EXEMPLARY EMBODIMENT

Hereinafter, exemplary embodiments of the present invention will be described with reference to the accompanying drawings such that those skilled in the art to which the present invention pertains can easily practice the present invention.

In the following description, the same elements will be designated by the same reference numerals although they are shown in different drawings.

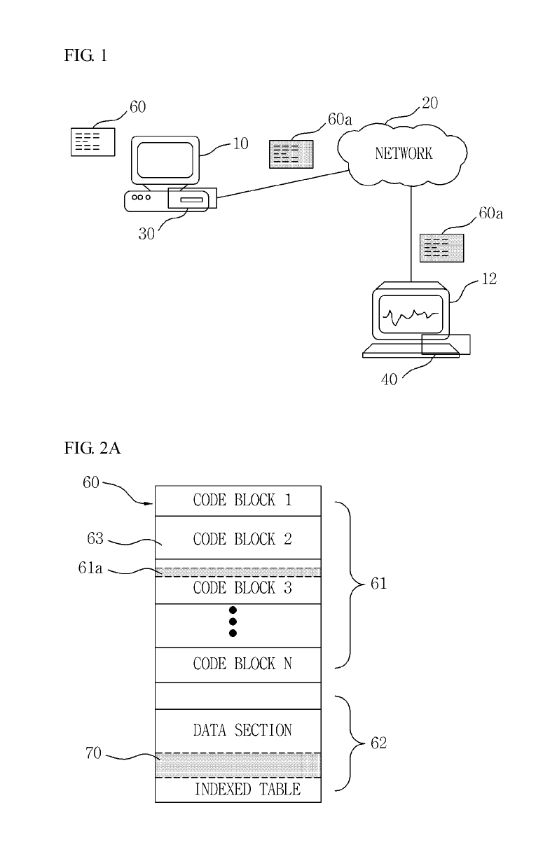

First, an example of an entire system for carrying out the present invention will be described with reference to FIG. 1.

As shown in FIG. 1, the entire system for carrying out the present invention includes an encrypting device 30 and a decrypting device 40.

The encrypting device 30 and the decrypting device 40 include programs installed in computer terminals 11 and 12 to be executed. The programs installed in the computer terminals 11 and 12 may be operated like one system 30 and 40. As an alternative embodiment, the encrypting device 30 or the decrypting device 40 may include one electronic circuit such as an application-specific integrated circuit (ASIC) to be implemented. That is, it may have a software form or a form of an electronic circuit with FPGA chips or several circuit elements. It may also be implemented in other possible forms. However, the encrypting device 30 or the decrypting device 40 realized in a computer terminal 11 or 12 will be described for convenience sake.

An executable file 60 may be stored in a storage medium of the computer terminal 11, and the stored executable file 60 may be fetched and input by the encrypting device 30. The encrypting device 30 encrypts an execution code of the executable file 60 and generates an encrypted executable file 60a.

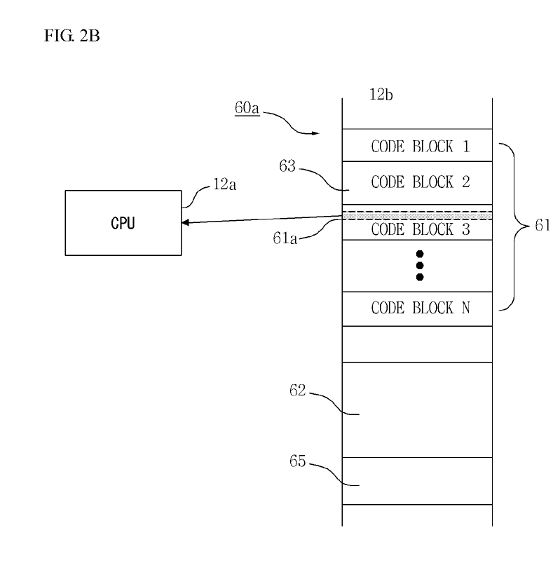

As illustrated in FIG. 2A, the executable file 60 is classified into an execution code section 61 and a data section 62. The execution code 61 is classified into a code block 62. Preferably, the executable file 60 includes an execution code 61 such as a binary code and an assembly code. While if the execution code 61 is directly implemented by a central processing unit CPU, it should be a machine code or a binary code, when it is interpreted by an interpreter to be executed, it should be an assembly code suitable for the interpreter.

The execution code section 61 is a section for storing an execution code such as an assembly code and the data section 62 is a section for storing data.

Then, the encrypting device 30 encrypts the execution code 61 in units of code blocks 63. Thus, it may also be decrypted in units of code blocks. For example, only “Code Block 3” can be decrypted separately.

The code block 63 includes a series of execution codes 61a. While the term “execution code” refers to the entire execution codes, it may also be used as a line of execution codes.

The execution codes 61a in the code block 63 are sequentially executed and the final execution code 61a in the code block 63 are the call code, in which case if the call code is executed, it proceeds to another block 63 to be executed. The call code refers to a jump or branch code in an assembly code. That is, the next execution code is not sequentially executed by the call code of the code block 63 but a code block 63 at another position is newly started.

Information on the code block of the execution code is stored in an indexed table 70. The indexed table 70 is stored in the data section 6. The indexed table 70 is a table that stores the addresses (or start addresses) of code blocks, the sizes of the blocks, and the number of calls. Preferably, the indexed table 70 may be encrypted by an initial key to be stored. The entire data section may also be encrypted by an initial key to be stored.

As describe above, the encrypted executable file 60a is distributed through a network 20 or on an off-line network. The distributed executable file 60a is installed in the computer terminal 12 to be executed.

As shown in FIG. 2B, the execution code 61 and the data section 62 of the executable file 60a are loaded onto the computer terminal 12 to reside in it. The executable codes 61a are fetched by the CPU 12a of the computer terminal 12 by one line (command) to be executed. Then, the entire execution code 61 may be loaded onto the memory 12b, or only some segments of the execution code 61 may be loaded. Then, one line of the execution code is identified by an address and one code block includes a plurality of execution codes (line commands).

Meanwhile, when the executable file 60a is loaded and executed (i.e. at run-time), a fixed data section 62 and a variable data section 65 for a stack or variable data are created even in the executable file 60a. Hereinafter, the variable data section 65 will also be described as a data section 62.

As mentioned above, one code block 63 is sequentially performed, and if the final execution code of the code block 63, i.e. a call code is executed, it jumps to another code block to be executed. It may occasionally be repeated in the same code block to be sequentially performed.

The decrypting device 40 is adapted to decrypt an execution code of an encrypted executable file 60 or 60a to execute the execution code. Then, the decrypting device 40 decrypts only a code block 63 to be executed, and encrypts the decrypted code block 63 again if the decrypted code block 63 is completely performed.

In the example of FIG. 2B, with the assumption that Code Block 1, Code Block 3, and Code Block 2 are sequentially performed, Code Block 1 is decrypted first. If Code Block 1 is completely performed, Code Block 3 that will be executed next is decrypted. If Code Block 3 is completely performed, Code Block 3 is encrypted and Code Block 2 is decrypted.

Next, the terms and their abbreviations used herein will be described with reference to FIG. 3.

IK denotes an initial key and protects both a random number and an indexed table. A random number encrypts a basic block (or code block) called by multiple blocks, and the initial key IK encrypts the random number. Protection and provision of the initial key IK entirely depends on an application, and the initial key IK may be stored in an external storage medium such as an external hard memory or a trusted platform module (TPM). Thus, it is assumed that the initial key is safely distributed and stored in an off-line network.

The random number encrypts a code block called from two code blocks or more and encrypts the initial key IK. A protected key PK denotes a random number encrypted by the initial key IK. The protected key PK is stored in a data section (or data section) of a binary code (or executable file). The encryption/decryption algorithm uses a conventional technology, and a detailed description thereof will be omitted.

Eₖ(•) and Dₖ(•) denote encryption and decryption with secret keys K. H(•) denotes a one-way hash function.

Next, the requirements for the indexed table based encrypting/decrypting device and a method thereof, i.e. the requirements for a safe code encryption scheme will be described.

The first requirement is confidentiality. An original binary code (execution code or assembly code) should be protected from static analysis by maintaining confidentiality. To protect a binary code from dynamic analysis such as data flow or control transportation, a minimal number of code blocks should be present in a memory. As long as a code remains encrypted in a memory, a program can be protected from static and dynamic analyses.

Second, memory dump prevention should be secured. If a single routine encrypts a whole program, the decryption routine decrypts the whole program and sets up its entry point, in which case it becomes vulnerable to a memory dump. Thus, only the minimal segments of the program should be decrypted and the other segments the program should remain encrypted.

Third, a correct key-chain should be secured. When a code encryption is applied to a program, a correct key-chain is required. If it does not have a correct key-chain for multiple paths, the system can crash or engage in an undesired execution.

Fourth, it should satisfy tamper-resistance. To protect the system from tampering, it should maintain integrity. So, the following properties are necessary.

In the encryption process, a one-bit change in a basic block should affect all encrypted blocks.

In the decryption process, if one or more bits are modified in an encrypted basic block B′, the result of decryption should be changed by one or more bits.

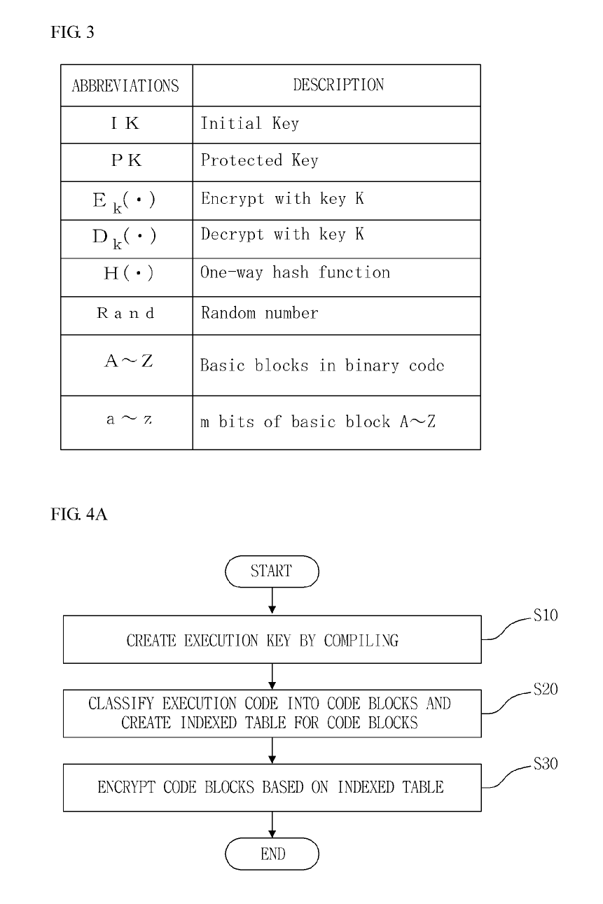

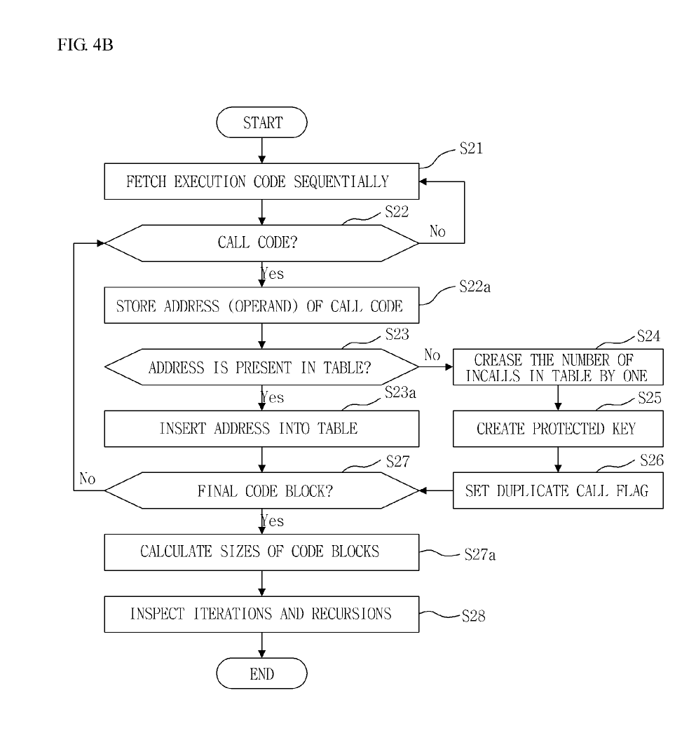

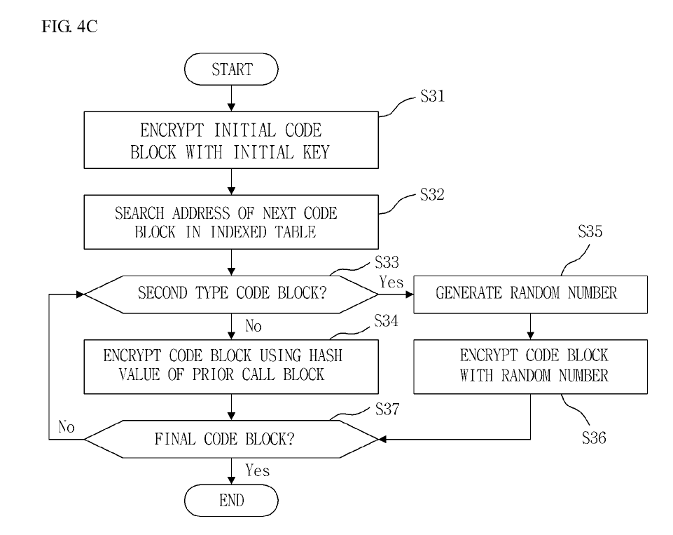

Next, an indexed table based code encrypting method according to an embodiment of the present invention will be described in more detail with reference to FIG. 4.

As shown in FIG. 4A, the indexed table based code encrypting method according to the present invention includes (a) a source code compiling step (S10), (b) an indexed table constructing step (S20), and (c) a code block encrypting step (S30).

In the step (a), an execution code (assembly code or binary code) is created by compiling a program source code.

In the step (b), the execution codes are classified into code blocks by a call code to construct an indexed table using information regarding the number of calls and the start addresses of the code blocks (S20). Then, an encryption key is created and stored for a code block (or second type code block) whose number of calls is two or more using a random number.

Then, a code block called twice or more may be known as a second type code block, and the other code blocks may be known as first type code blocks. The number of calls of the first type code block is one. Meanwhile, the first code block is assumed to be called once by the initial start of the program.

Next, the step (c) will be described first prior to explaining the step (b) in detail.

As shown in FIG. 4C, in the step (c), a code block is encrypted with an encryption key. Then, the encryption key of the code block called once is created by using a code block (hereinafter, call block) calling it. That is, it is encrypted by using the call block. The code block called twice or more is encrypted though an encryption key created by using a random number. For example, a code block is encrypted by using a random number itself as an encryption key.

The code block (or first type code block) is encrypted by using Equation 1.

Cᵢ=Enc_{H(P}_{ᵢ₋₁}₎(Pᵢ), where H(P₀)=IK.

Here, i is a sequence number of the code block in the indexed table. If a flag (or multi-path flag) is not zero, the block is encrypted by a random number. The initial key IK encrypts the random number and then is stored in an executable file. This encryption step is needed because if the random number is exposed, the blocks can be decrypted by the random number and then be analyzed by an attacker.

The indexed table is used to make a correct key chain. The table construction procedure is as follows. First, after the current address of the basic block (or code block) is stored, a call code (commands such as jump or branch) is executed by moving a pointer. The commands contain the address of the code block to be executed next (as an operand).

If the next address (operand of a call code) indicates the current basic block, this indicates a loop (or iteration) or a recursion. When a loop or recursion occurs, the number of calls can be determined by a cmp command or the like and the number of calls is stored in the table. Likewise, if the current block has already been stored in the table, this indicates multiple calls (called twice or more) of the code block. Then, the protected key PK is generated and is stored in a data section of a binary image (or binary image of the executable file). The protected key PK is adapted to encrypt a random number and is used as an encryption key for allowing a random number to encrypt the code block.

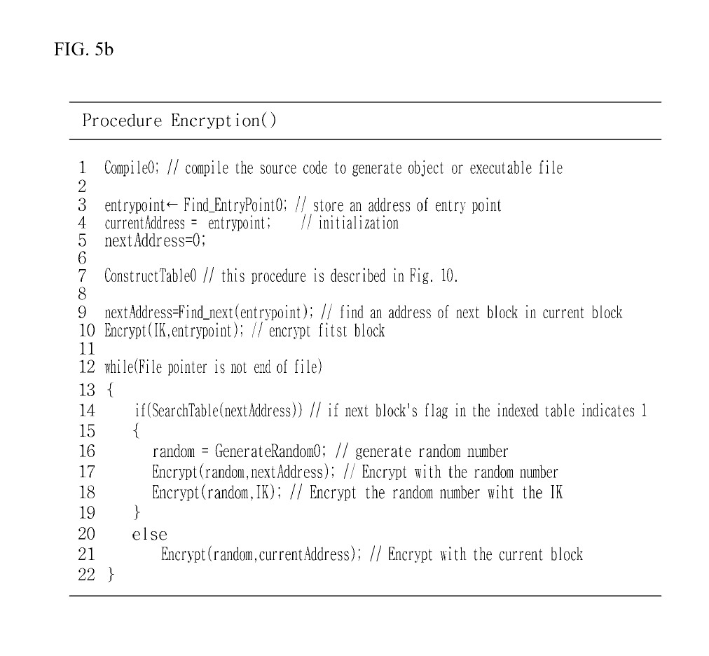

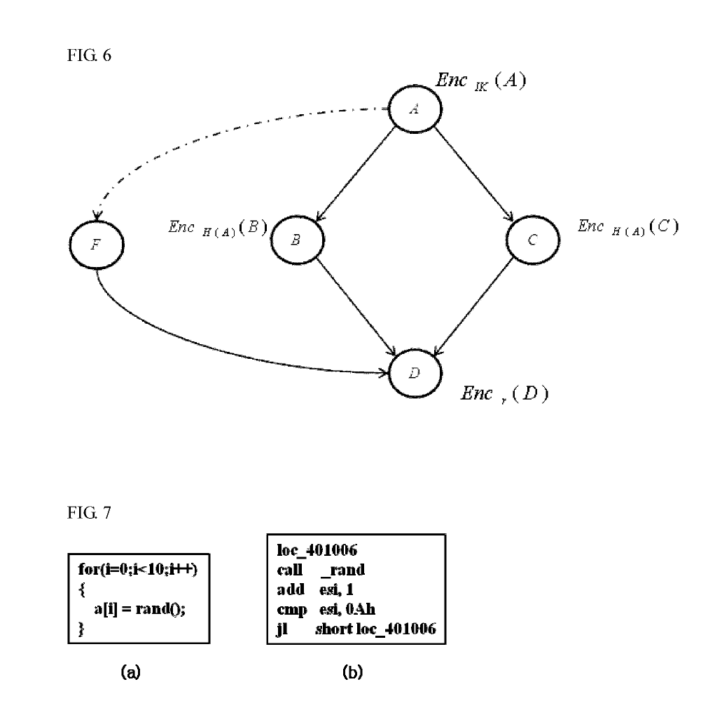

As shown in FIG. 6, a basic block (or code block) is called by multiple blocks B, C and F. That is, it is called by three different code blocks. The encryption key of B is a hash value of the block A and is the same as the secret key of C. F is not directly called and is called by D. Then, a random number r is created with the secret key (or encryption key) of D and is encrypted with the initial key IK again. The result is new creation of a protected key PK which is stored in a binary file (or executable file). The protected key PK denotes a value obtained by encrypting a random number r by the initial key K.

A general computer operating system such as Linux or Window supports a data section where a parameter can be stored in an image of an executable file, and the protected key can be stored in the data section present in the executable file.

The indexed table includes the number of iterated calls. If it is not considered, the basic block (or code block) that means a loop or a recursion may be decrypted several times. Thus, such a problem can be solved by indicating the loop or the number of recursions in the table. If the basic block is called, the number of calls stored in the table is reduced by one such that the block is re-encrypted to prevent memory dump if the number of calls becomes zero.

For example, in the case of a loop, an example of use of C language is as shown in FIG. 7. The second operand of the cmp command is “0A”. This indicates that the block “loc_{—}401006” will be carried out 10 times which is the number of loops or recursions.

In more detail, referring again to FIG. 4C, the initial code block P₀ is encrypted with the initial key IK (S31). The address (start address) and type of the next code block is fetched from the indexed table (S32) to determine the type of the code block (S33). The flag (or multiple path call flag) in the indexed table is “0”, the code is a first type code block, and otherwise, it is a second type code block.

If the current code block Pᵢ is a first type code block, the prior call block (or prior code block in the indexed table) Pᵢ₋₁ is hashed to encrypt the current code block Pᵢ with a hash value H(Pᵢ₋₁) (S34). If the current code block Pᵢ is a second type code block, a random number is generated (S35) such that the current code block is encrypted with the random number r (S36). Then, the random number generated in the step (b) may be used or if a random number is generated in the step (b), a random number is generated in the step.

It is checked if the current code block Pᵢ fetched from the indexed table is the final code block (S37), and if it is final, the process is completed, and otherwise, the next code block is fetched to repeat the steps.

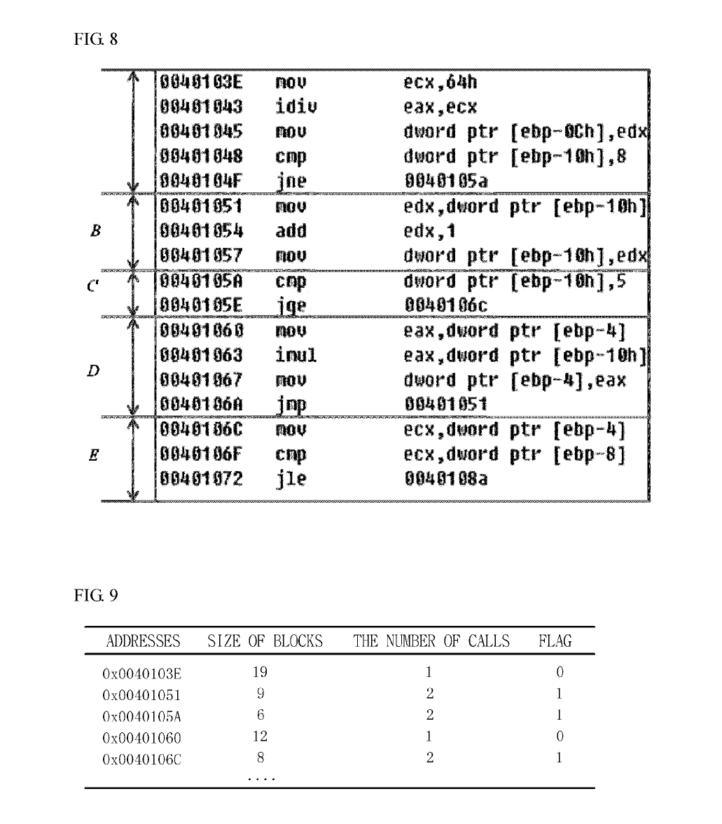

Next, the step (b) will be described in more detail with reference to FIGS. 4B, 8, and 9. FIG. 4B is a flowchart illustrating a step of constructing an indexed table and FIG. 9 illustrates an example of constructing an indexed table from an example of an execution code.

As shown in FIG. 8, the exemplary code (or execution code) may be composed of five basic blocks. The basic blocks (or code blocks) are divided by jump or branch commands. At first, initialization is performed to construct the indexed table. 0x0040103E is set as an entry point of the program. Then, jump or branch commands are searched.

As shown in FIG. 9, if the command is jump or branch, the operand is stored in the table because it becomes the first address of another block. For example, 0x0040105A is stored in the table because of the command “jne 0x0040105A” which is at 0x0040104F. That is, 0x00401051 is stored in the indexed table. In this way, 0x0040106C and 0x00401060 are sequentially stored. At 0x0040106A, the command “jmp 0x00401051” is identified. Since 0x00401051 has already been in the table, it may be a block called a plurality of times. Thus, the block's information should be updated and a random number should be generated. In this way, all the blocks can be identified.

The addresses in the indexed table of FIG. 9 are the start addresses and serve as an identifier. The number of calls is the number of calls of the code block by another code block. The flag is a multiple path call flag, wherein it is recorded as “0” if the number of calls is one, and otherwise, it is recorded as “1”.

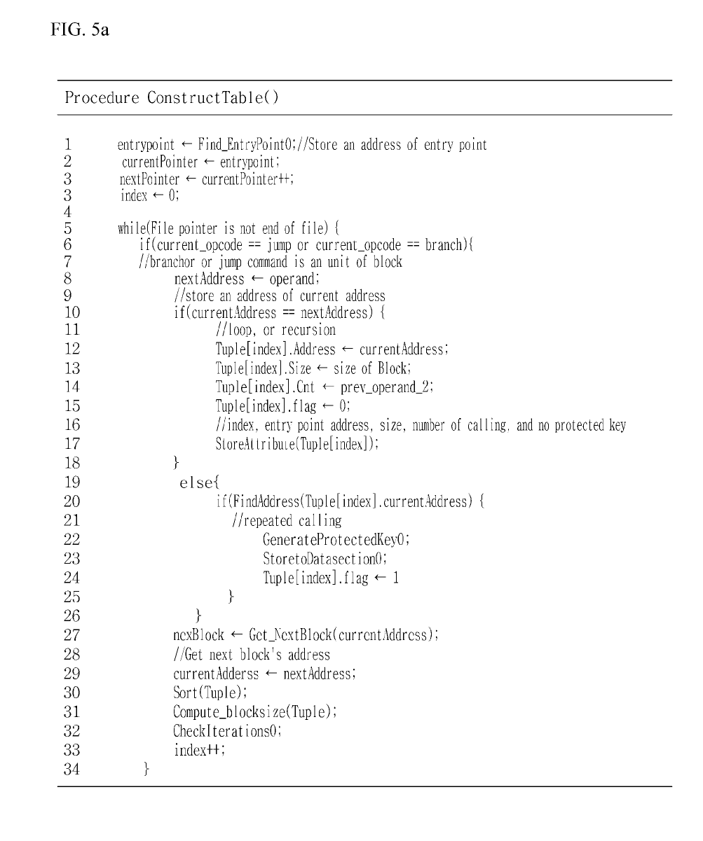

The pseudo-codes for the steps (b) and (c) are as shown in FIGS. 5A and 5B.

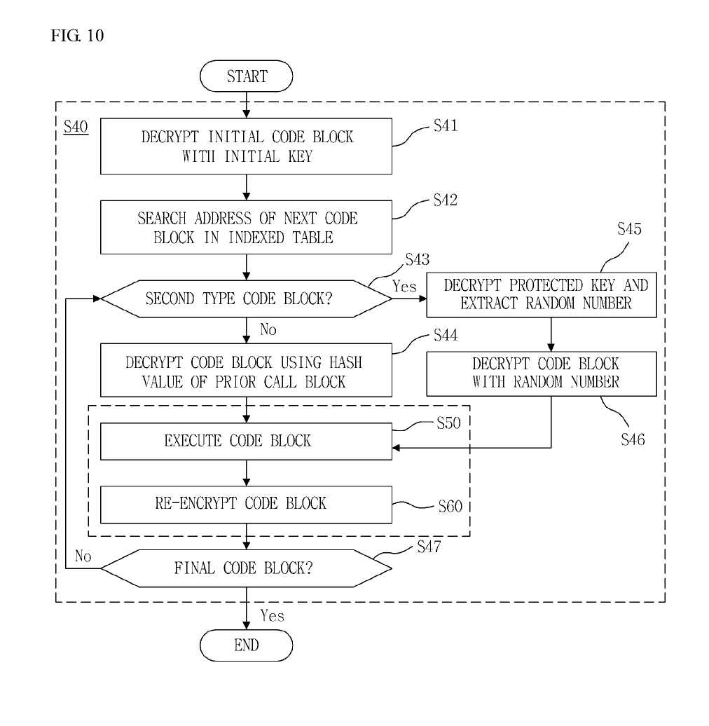

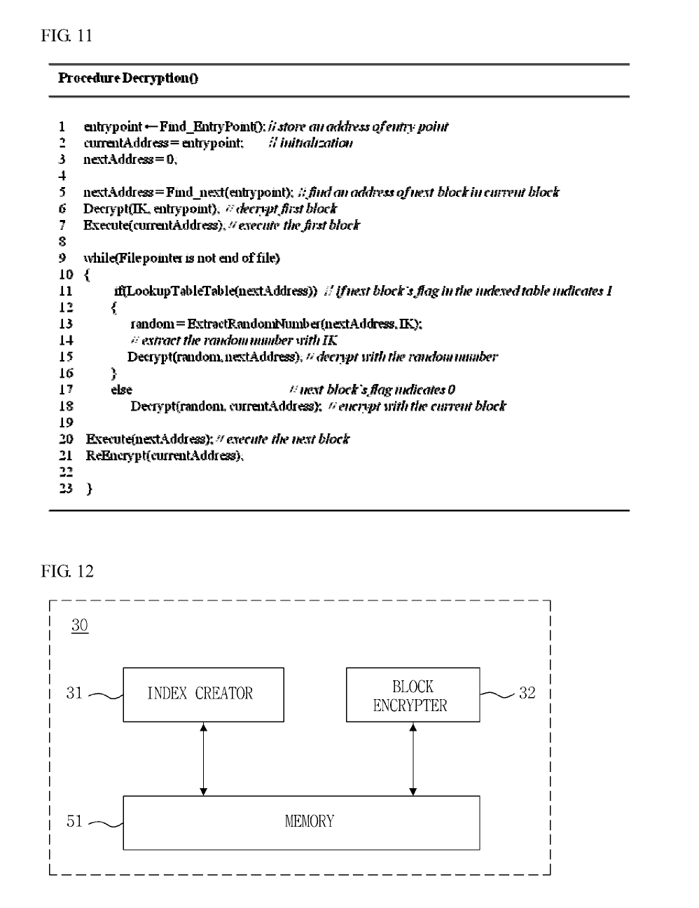

Next, an indexed table based code decrypting method according to an embodiment of the present invention will be described in more detail with reference to FIG. 10.

As shown in FIG. 10, the indexed table based code decrypting method according to the present invention includes (d) a step of decrypting a code block (S40), (e) a step of executing an execution code of the code block (S50), and (e) re-encrypting the decrypted code block (S60).

First, the initial code block decrypts an initial key IK (S41). If execution of the initial code block is completed, the next code block is fetched. Then, the address of the next code block is searched from the indexed table (S42). It is determined of which type (first type or second type) the next code block is (S43), and if it is of the first type, the prior code block (or call block) is hashed such that the code block is decrypted by using the hash value as an encryption key (S44). If it is of the second type, the stored protected key is fetched and is decrypted with the initial key IK to extract a random number (S45) and the extracted random number is used as an encryption key to decrypt the code block (S46). Then, the code block is executed, and the executed code block is re-encrypted (S60). If all the code blocks are completed and the code block is final, the step is ended (S47).

That is, in the step (d), an encrypted execution code of the executable file is decrypted by using the encryption key of the code block in units of code blocks, in which case, referring to the indexed table, if the code block is a first type code block, an encryption key is created with the call block of the code block, and if the code block is a second code block, a stored encryption key (or a random number obtained by decrypting the protected key) of the code block is used.

First, prior to starting of a program, the entry point of the program is searched by using the indexed table. Then, the encrypted code block C, is decrypted with an execution code or a code block Pᵢ. The encrypted code block is decrypted by using the hash value of the prior block to execute the decrypted code Pᵢ. If the prior block Pᵢ₋₁ is tampered with and becomes P′ᵢ₋₁, the encryption key H(Pᵢ₋₁) is not H(P′ᵢ₋₁). Thus, the code block Pᵢ will not be decrypted properly.

Meanwhile, the indexed table includes a flag. The flag is a flag indicating whether or not the code block uses a random number. If the flag is 1, the encrypted code block should be decrypted with a random number. If code decryption is completed, the decrypted code block is re-encrypted and is stored in a memory.

Next, the indexed table based code encrypting device 30 according to the embodiment of the present invention will be described in more detail with reference to FIG. 12.

As shown in FIG. 12, the encrypting device 30 according to the present invention includes an index creator 31, and a block encrypter 32.

The index creator 31 classifies the execution codes of the executable file into code blocks using a call code and stores the number of calls and the start addresses of the code blocks in an indexed table.

The block encrypter 32 encrypts a code block with an encryption key, and creates an encryption key of a code block (hereinafter, first type code block) called once with a code block (hereinafter, call block) calling the first type code block and creates an encryption key of a code block (hereinafter, second type code block) called twice or more with a random number and stores it in the executable file.

Then, the executable code is a binary code or an assembly code, and the call code is a branch code or a jump code of the binary code or the assembly code.

Meanwhile, the index creator 31 classifies a series of execution codes including a final execution code as a call code into one code block, and the call code calls another code block other than the code block including the call code. The index creator 31 stores the number of calls of the code block in the indexed table, and increases the number of calls of the code block called by the call code one by one to store it. The index creator 31 stores the size of the code block in the indexed table.

The block encrypter 32 creates an encryption key of the first type code block by hashing the call block of the first type code block. The block encrypter 32 determines the encryption key of the initial code block as an initial key. The block encrypter 32 encrypts the encryption key of the second type code block as the initial key and stores it in the data section of the executable file. Preferably, the block encrypter 32 stores the indexed table in the data section of the executable file.

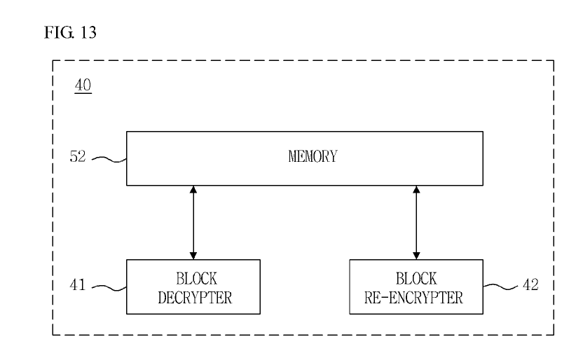

Next, the indexed table based code decrypting device 40 according to an embodiment of the present invention will be described in more detail with reference to FIG. 13.

As shown in FIG. 13, the decrypting device 40 according to the present invention includes a block decrypter 41, and a block re-encrypter 42.

The block decrypter 41 decrypts an encrypted execution code of the executable file in units of code blocks using an encryption key of the code block, and referring to the indexed table, if the code block is a first type code block, an encryption key is created with the call block of the code block and if it is a second type code block, a stored encryption key of the code block is used.

The block re-encrypter 42 re-encrypts the code block if the final call code of the decrypted code block is executed. In particular, when the code block is repeated, the block re-encrypter 42 stores the number of iterations in the indexed table and reduces the number of iterations whenever the code block is called. If the number of iterations becomes zero, the code block is re-encrypted.

The omitted descriptions of the encrypting or decrypting device can be referred to in the description of the encrypting or decrypting method.

The present invention is useful in development of an indexed table based code encrypting/decrypting device that encrypts/decrypts a code block called once with the prior call code block and encrypts/decrypts a code block called twice or more with an encryption key produced by using a random number.

While the invention has been shown and described with reference to certain exemplary embodiments thereof, it will be understood by those skilled in the art that various changes in form and details may be made therein without departing from the spirit and scope of the invention as defined by the appended claims.

1. An indexed table based code encrypting device adapted to encrypt an executable file of a computer program comprising:
an index creator configured to classify codes of the executable file into code blocks using a call code and store the number of calls and start addresses of the code blocks; and
a block encrypter configured to encrypt the code blocks with encryption keys,
wherein an encryption key of a code block (hereinafter, first type code block) called once is created by using a code block calling the first type code block and an encryption key of a code block (hereinafter, second type code block) called twice or more is created by using a random number, and
wherein the encryption keys of the first and second type code blocks are stored in the executable file.

2. The indexed table based code encrypting device as claimed in claim 1, wherein the execution code is a binary code or an assembly code and the call code is a branch code or a jump code of a binary code or an assembly code.

3. The indexed table based code encrypting device as claimed in claim 1, wherein the index creator classifies a series of execution codes including a final execution code as a call code into one code block, and the call code calls another code block other than the code blocks containing the call code.

4. The indexed table based code encrypting device as claimed in claim 1, wherein the index creator stores the number of calls of the code block in the indexed table and the number of calls of the code block called by the call code is increased one by one for the call codes of the code blocks to be stored.

5. The indexed table based code encrypting device as claimed in claim 1, wherein the block encrypter hashes the call block of the first type code block and creates an encryption key of the first type code block.

6. The indexed table based code encrypting device as claimed in claim 1, wherein the block encrypter determines an encryption key of an initial code block as an initial key.

7. The indexed table based code encrypting device as claimed in claim 1, wherein the block encrypter encrypts an encryption key of the second type code block as an initial key and stores the encrypted encryption key in a data section of the executable file.

8. The indexed table based code encrypting device as claimed in claim 1, wherein the block encrypter stores the indexed table in a data section of the executable file.

9. The indexed table based code encrypting device as claimed in claim 1, wherein the index creator stores the size of the code block in the indexed table.

10. An indexed table based code decrypting device adapted to decrypt an executable file encrypted by a device as claimed in claim 1, comprising:
a block decrypter configured to decrypt an encrypted execution code of the execution file in units of code blocks using an encryption key of the code block, and referring to the indexed table, to create and use an encryption key with a call block of the code block if the code block is a first type code block and to use a stored encryption key of the code block if the code block is a second type code block; and
a block re-encrypter configured to re-encrypt the code block if a final call code of the decrypted code block is executed.

11. The indexed table based code decrypting device of claim 10, wherein when the code block is iterated, the block re-encrypter stores the number of iterations in the indexed table and decreases the number of iterations whenever the code block is called and re-encrypts the code block if the number of iterations is zero.

12. An indexed table based code encrypting method for encrypting an executable file of a computer program, comprising the steps of:
(b) classifying execution codes of the executable file into code blocks by a call code, storing the number of calls and start addresses of the code blocks in an indexed table, and creating an encryption key for a code block (hereinafter, second type code block) called twice or more with a random number to store the encryption key; and
(c) encrypting the code block with an encryption key of the code block and creating an encryption key of a code block (hereinafter, first type code block) called once using a code block (hereinafter, call block) calling the first type code block.

13. The indexed table based code encrypting method as claimed in claim 12, wherein the execution code is an assembly code and the call code is a branch code or a jump code of the assembly code.

14. The indexed table based code encrypting method as claimed in claim 12, wherein the step (b) comprises the steps of:
(b1) inspecting the execution codes sequentially;
(b2) extracting, if the inspected execution code is a call code, an address from an operand of the call code;
(b3) inserting, if the address is not present in the indexed table, the address into the indexed table as a start address of the code block;
(b4) increasing, if the address is present in the indexed table, the number of calls of the code block, corresponding to the address; and
(b5) generating, if the number of calls of the code block is once or more, an encryption key of the code block with a random key.

15. The indexed table based code encrypting method as claimed in claim 12, wherein the step (b) further comprises the step of (b6) calculating, if a final execution code of the executable file is inspected, the sizes of the code blocks and storing the sizes of the code blocks in the indexed table.

16. An indexed table based code decrypting method for decrypting an encrypted executable file as claimed in claim 12, comprising the steps of:
(d) decrypting an encrypted execution code of the executable file in units of code blocks using an encryption key of the code block, and referring to the indexed table, if the code block is a first type code block, creating an encryption key with the call block of the code block to use the encryption key and if the code block is a second type code block, using a stored encryption key of the code block; and
(f) re-encrypting, if a final execution code of the decrypted code block is executed, the code block.
